(19) United States
(12) Patent Application Publication
(10) Pub. No.: US 2010/0072841 A1
(43) Pub. Date: Mar. 25, 2010

(54) Tangent Seeker Magnetic Drive System and Method

(76) Inventor: Joe Rich, Miami, FL (US)

Correspondence Address: ROBERT M. SCHWARTZ, P.A., P.O. BOX 221470, HOLLYWOOD, FL, 33022, US

(21) Appl. No.: 12/234,810

(22) Filed: Sep. 22, 2008

(51) Int. Cl. H02K 7/12; H02K 21/12; H02N 11/00

(52) U.S. Cl. 310/80; 310/152; 415/916

(57) ABSTRACT

A magnetic drive system and method are provided wherein magnets on a stator interact with a magnet on the rotor to create repulsion and attraction forces that produce axial shaft rotation. More particularly, a magnet is pivotally attached to a carriage that processes about an annular magnet. The resultant magnetic forces interact with a magnet on the rotor shaft and cause the rotor shaft to turn.

### BACKGROUND OF THE INVENTION

1. Field of the Invention

The invention relates to a magnetic drive system and method and, more particularly, to a tangent seeking magnetic drive system having an eccentrically set magnetic rotor and an annular, magnetic stator.

2. Description of the Related Art

Magnetic drive systems are known. For example, U.S. Pat. No. 6,700,248 to Long discloses a non-linear magnetic motion converter for transferring nonlinear motion into rotational motion for producing work from an interaction of at least two magnetic fields. In one particular embodiment of Long, the motion converter includes a gimbal supported ring magnet disposed to reciprocate in a gimbal movement around an axis of rotation that is substantially parallel to a rotational shaft. Disposed in spaced apart configuration along the rotational shaft of Long is at least one rotor magnet, and preferably a pair of rotor magnets. Movement of the gimbal supported magnet of Long creates repulsion and attraction of each respective rotor magnet with inducement of axial shaft rotation, thereby producing rotational movement that is harnessed to perform work.

There is a need for a less complicated magnetic drive device.

### SUMMARY OF THE INVENTION

It is accordingly an object of the invention to provide a magnetic drive system and method wherein magnets on the stator interact with a magnet on the rotor to create repulsion and attraction forces that produce axial shaft rotation. In one particular embodiment of the present invention, a magnet is pivotally attached to a carriage that processes about an annular magnet. The resultant magnetic forces interact with a magnet on the rotor shaft and cause the rotor shaft to turn. Other features which are considered as characteristic for the invention are set forth in the appended claims.

Although the invention is illustrated and described herein as embodied in a Tangent Seeker Magnetic Drive System And Method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

The present invention is illustrated by way of example, and not by way of limitation, in the figures of the accompanying drawings, in which like reference numerals refer to similar elements and in which:

FIG. 1 is a side cross-sectional view of a drive system in accordance with one particular embodiment of the present invention;

FIG. 2 is a perspective view of a drive system stator in accordance with one particular embodiment of the present invention; and

FIG. 3 is a perspective view of one particular embodiment of a drive system rotor for use with the drive system stator of FIG. 2.

FIG. 4 is a simplified diagram showing certain interactions within the stator portion of one particular embodiment of the present invention.

### DESCRIPTION OF THE PREFERRED EMBODIMENTS

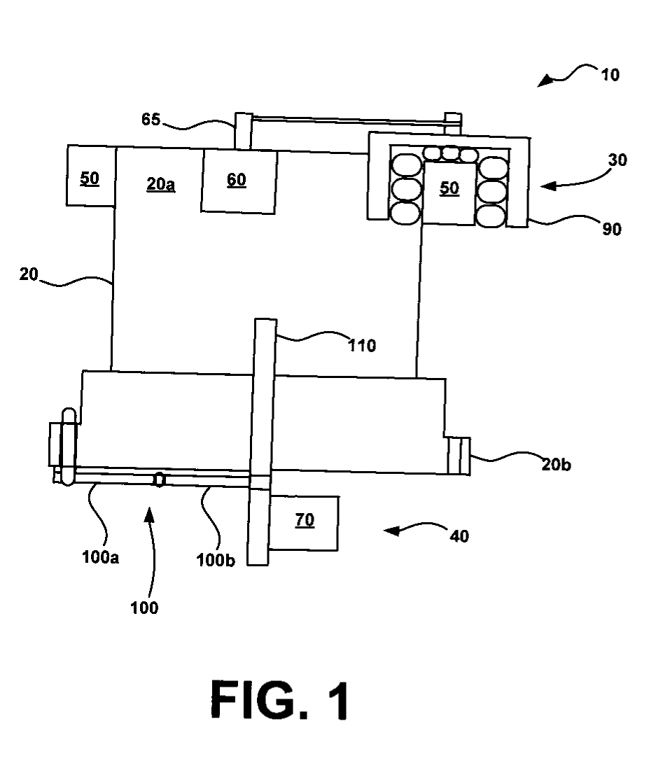

Referring now to FIGS. 1-3, there is shown a magnetic drive system including a frame or body 20 supporting a stator portion 30 and a rotor portion 40. The body 20 can include a flange 20b, which permits the body to be fixedly attached to a surface, to prevent movement of the body and the annular magnet 50 affixed thereto.

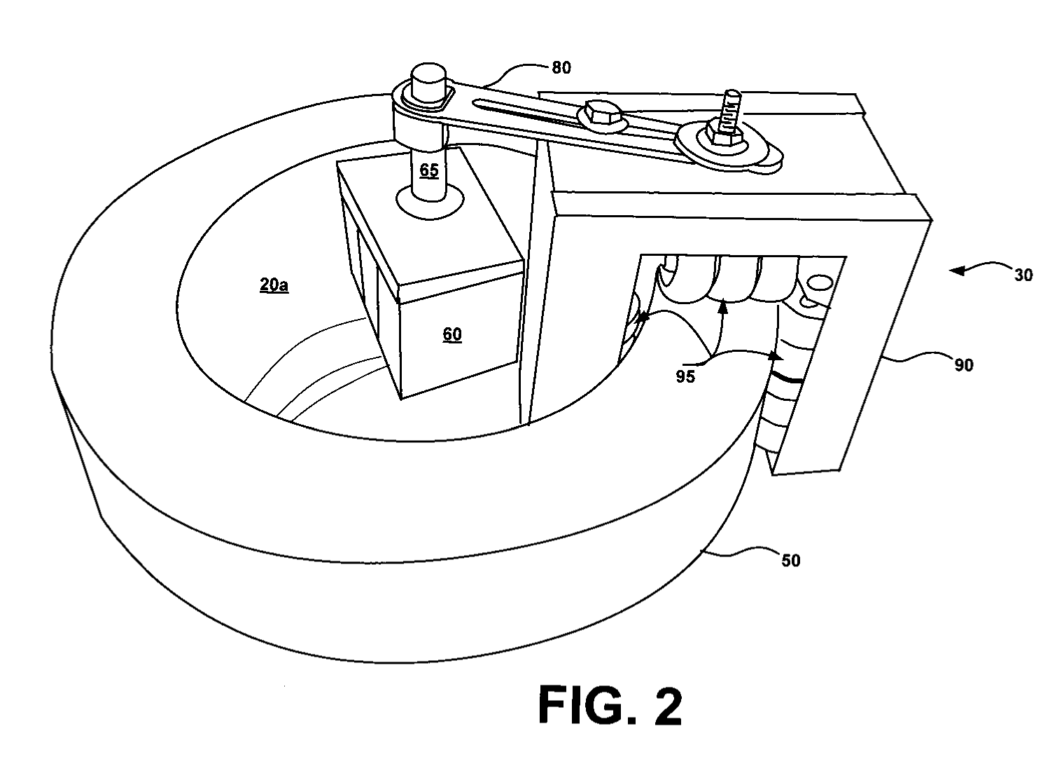

Referring more particularly to FIGS. 1 and 2, the stator portion 30 of the magnetic drive unit 10 includes an annular magnet 50 fixed to the uppermost portion of the body 20. Annular magnet 50 can be of a known type of annular magnet, such as a ceramic ring magnet, or can be another type of ring magnet, including one formed from individual bar magnet portions. Stator portion 30 additionally includes a further stator magnet 60, the magnetic field of which interacts with both the magnetic field of the annular magnet 50 and a magnet 70 of the rotor portion 40.

The annular magnet 50 includes an inner ring surface of a first polarity and an outer ring surface of an opposing polarity. For example, in one particular embodiment of the present invention, the inner ring surface of the magnet 50 is designated as being the north pole of the annular magnet 50, while the outer ring surface is the south pole. Note that this is not meant to be limiting, as, in another embodiment, the inner ring surface of the annular magnet 50 could be the south pole, while the outer ring surface would be the north pole.

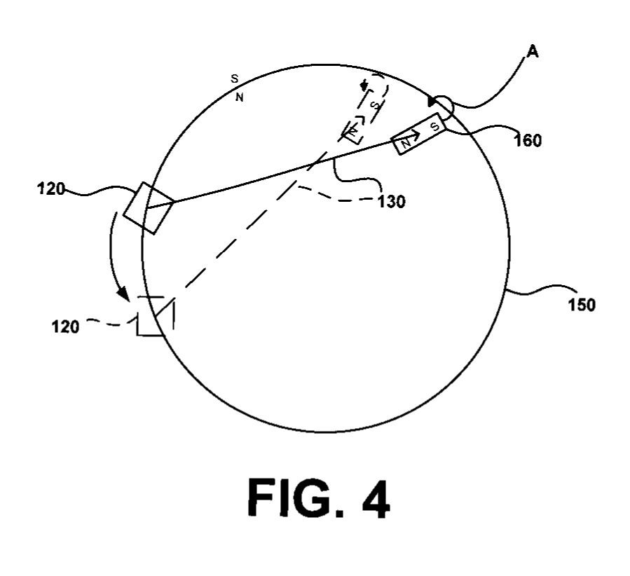

The stator magnet 60 is located within the annular magnet 50, and interacts with the magnetic field of the inner ring surface of the annular magnet 50, so as to always be seeking a tangential orientation to the surface of the inner ring of the annular magnet 50 (see, for example, FIG. 4). Stator magnet 60 can be a bar magnet, as known in the art, or can be made up of a plurality of magnetic portions (as shown in FIG. 2) or other magnetic materials. The stator magnet 60 is rotatably mounted to a lever arm 80, which is pivotally fixed to a carriage 90. The carriage 90 rides along at least the upper surface of the annular magnet 50 on the wheels or bearings 95. Note that the bearings 95 can be magnetic bearings, if desired. Additionally, in the preferred embodiment shown in FIGS. 1 and 2, the carriage 90 contacts three surfaces of the annular magnet 50, in order to provide stability.

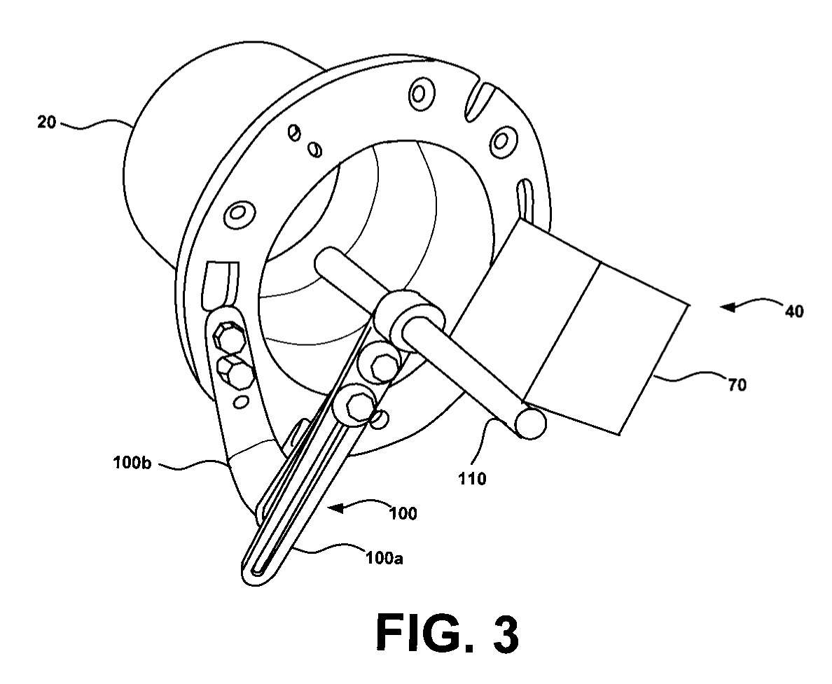

Referring now to FIGS. 1 and 3, there is shown a rotor portion 40. The rotor portion includes a pivoting linkage or lever arm 100, made up of the hinged components 100a and 100b, one end of which is rotatably fixed to the lower portion of the body 20, whereas the other end of the lever arm (i.e., the “free” end) is rigidly fixed to a shaft 110. The rotor magnet 70 is mounted to the shaft 110. A magnetic interaction between the annular magnet 50, the stator magnet 60 and the rotor magnet 70 will cause the shaft 110 to turn, thus creating a rotational energy which can be harnessed to perform work.

More particularly, the poles of the stator magnet 60 will be alternately attracted to and repelled by the magnetic fields of the rotor magnet 70 and the annular magnet 50, causing the stator magnet 60 to spin on its axle 65. The magnetic field interactions between the magnets 50. 60 and 70 additionally causes the carriage 90 to process around the periphery of the annular magnet 50. Movement of the carriage 90 causes further movement of the stator magnet 60 relative to the annular magnet 50 and the rotor magnet 70, thus changing the interaction of their relative magnetic fields. The interaction of the magnetic fields of the stator magnet 60 on the rotor magnet 70 contributes to the rotation of the shaft 110 as the carriage 90 processes about the annular magnet 50.

Referring now to FIG. 4, in theory, if the annular magnet 150 and/or the stator magnet 160 are strong enough, placing the stator magnet 160 into the center of the annular magnet 150 will result in the stator magnet 160 moving out of center position, toward the inner ring surface of the annular magnet 150. More particularly, the inner surface (i.e., in the present example, the “north pole”) of the annular magnet 150 will repel the north pole of the stator magnet 160, while simultaneously attracting the south pole of the stator magnet 160. As such, in the present example, the south pole of the stator magnet 160 will be drawn towards the inner ring surface of the annular magnet 150. Note that, although the stator magnet 160 will change horizontal (i.e., x, y) position within the annular magnet 150, the stator magnet will not change vertical (i.e., z) positions during this travel. Rather, the stator magnet 160 will remain in a plane defined through the middle or “equator” of the annular magnet 150 (i.e., the stator magnet 160 will not move vertically within the annular magnet 150).

To add torque to the motion of the stator magnet 160, the stator magnet 160 is moved off center in the annular magnet 150 by the lever arm 130. In the present example, moving the stator magnet 160, as shown in FIG. 4, (i.e., via the carriage 120) will add torque to the stator magnet 160 causing it to rotate in the direction of arrow “A”. Correspondingly, moving the stator magnet 160 in the opposite direction will cause the stator magnet 160 to rotate in the opposite direction to arrow “A”, as a result of the added torque caused by the movement. Additionally, the rotational speed of the rotor shaft (110 of FIG. 1) can be adjusted by varying the distance of the stator magnet 160 from the center of the annular magnet 150.

In operation, as can be seen from FIG. 4, the stator magnet 160 is not located in the center of the annular magnet 150, but rather, closer to the inner surface of the annular magnet 150. This permits the stator magnet 160 to seek a tangent to the inner ring surface of the annular magnet 150, propelling the carriage 120 and the stator magnet 160, and correspondingly, turning an associated rotor shaft (110 of FIGS. 1 and 3). In one preferred embodiment, the center point of the stator magnet is located by the lever arm at least half the distance from the center of the annular magnet 150 to the inner surface of the annular magnet 150. In a more preferred embodiment, the stator magnet 160 is located at least two thirds of the distance from the center of the annular magnet 150 to the inner surface of the annular magnet 150. In an even more preferred embodiment, the stator magnet 160 is located as close as possible to the inner surface of the annular magnet 150, while still permitting free rotation of the stator magnet 160 about its axis (i.e., providing sufficient clearance for the longest dimension of the magnet 160).

Note that the above-described embodiments are exemplary and that the above invention is not meant to be limited only to its preferred embodiments. It can be seen that other modifications can be made to the preferred embodiments and still be within the spirit of the present invention.

I claim:

1. A magnetic drive system, comprising:
an annular magnet;
a second magnet located off-center within said annular magnet;
a carriage connected to said second magnet by a lever arm, said carriage riding on the upper surface of said annular magnet; and
said second magnet interacting with said annular magnet resulting in said carriage moving around the periphery of said annular magnet.

2. The system of claim 1, further comprising a third magnet interacting with at least said second magnet, said third magnet being attached to a shaft, such that movement of said second magnet about the inner periphery of said annular magnet results in rotation of said shaft.

3. A method for rotating a shaft, comprising the steps of: providing a drive device, including:
an annular magnet;
a second magnet located off-center within the annular magnet;
a carriage connected to the second magnet by a lever arm, the carriage riding on the upper surface of the annular magnet;
initiating the movement of at least one of the second magnet and the carriage, the movement causing a magnetic interaction that results in rotation of a shaft.

4. The method of claim 3, wherein the providing step further includes providing a third magnet that interacts with at least the second magnet, the third magnet being attached to the shaft.
